(19) United States
(12) Patent Application Publication
(10) Pub. No.: US 2009/0000930 A1
(43) Pub. Date: Jan. 1, 2009

(54) Electrical Switching and/or Actuating Element With a Visual Display

(75) Inventor: Christopher Adams, Hamburg (DE)

Correspondence Address: SAND & SEBOLT, AEGIS TOWER, SUITE 1100, 4940 MUNSON STREET, NW, CANTON, OH, 44718-3615, US

(73) Assignee: SYNTHAX ASIA LTD., Kwai Chung, HK (CN)

(21) Appl. No.: 12/159,800

(22) PCT Filed: Dec. 21, 2006
(86) PCT No.: PCT/EP06/12398

§ 371 Date: Jul. 1, 2008

(30) Foreign Application Priority Data
Jan. 19, 2006 (EP) 06001092.3

(51) Int. Cl. H01H 9/00

(52) U.S. Cl. 200/316; 200/308

(57) ABSTRACT

To modify an electrical switching and/or setting element (1) with a rotary switch (4) as handle, in such a way that it can be used in a broader range of applications, particularly with feedback in the form of information issued to the operator, it is proposed to arrange, in the rotary switch (4), an optical display device (8) for displaying at least two different symbols.

The invention relates to an electrical switching and/or setting element with a rotary switch as handle.

Such switching and/or setting elements are known. For example, switching elements exist with a rotary switch with predetermined detent positions for controlling a great variety of switch positions or also potentiometers with or without haptically perceivable detent positions.

These switching and/or setting elements are used commonly, for example, as regulators for loudness levels, control elements for transformers or similar devices. Here, these electrical switching and/or setting elements are used typically exclusively “in one direction,” namely for setting or resetting switching positions or for regulating currents respectively voltages. Another use, where a return data stream flows particularly into the switching and/or setting element, does not exist here. The invention is intended to overcome this deficiency.

According to the invention, it is proposed to solve this problem by means of an electrical switching and/or setting element of the type mentioned in the introduction, which contains an optical display device for displaying at least two different symbols, where the device is arranged in a rotary switch.

The electrical switching and/or setting element thus allows the transmission of data via optical paths that are associated, for example, with a switching position of the switching element, or with an event that is triggered by this switching position. For this purpose, the display contains at least two different symbols, so that two different events can be distinguished optically. The greater the content of different symbols is, the more differentiated the displays produced are. In addition, if the displayed symbols are colored differently, the possibility for an additional differentiation exists.

The symbols can be, for example, letters, numbers, pictograms or other types of representations that are suitable for the transmission of certain data to be displayed optically.

The arrangement of the optical display device on the rotary switch is in principle of any type. However, it has been found to be particularly efficient if the displayed device is arranged on a front surface of the rotary switch.

In a preferred embodiment (claim 2), the optical display device contains active light sources as well as a mask applied to these light sources, with openings in the shape of the symbols. It is preferred for the light sources to be light emitting diodes (LEDs) here. These LEDs can be based on the semiconductor technology or they may be modern organic LEDs. In particular, several LEDs of different colors can be arranged under the mask with the openings in the shape of the symbols, in the area of each opening, so that one and the same symbol can be displayed in a different color, thus allowing another possibility for differentiation in the data transmission.

In this case, the display functions in such a way that light exiting from the active light source passes through the mask and thus generates a light spot in the form of a symbol, which can be perceived by the operator of the electrical switching and/or setting element.

To be able to limit the light of the individual light sources reliably to such an area, which is covered by a opening in the mask, shutters can be arranged between the light source and the mask (claim 3). Here, the arrangement provides first a light source, above it, in alignment with the light source, a shutter, and above the latter then the mask with the opening representing the symbol, again in alignment with the light source and the shutter opening.

To generate an impression of an even illumination of the opening in the mask, which represents the symbol, it is preferred to arrange a diffuser on the side of the mask, which is turned away from the light source (claim 4). Such a diffuser consists usually of an opaque material, but, in the simplest case, it can be formed from opaque parchment paper.

Finally, it is advantageous for the entire display device that is provided with the active light sources to be covered with a transparent cap, which is preferably in the form of a converging lens. (Claim 5). This transparent cap offers first protection for the elements located beneath it. If the cap is designed in the form of a converging lens, a magnification effect is achieved additionally, which allows an easily recognizable representation of the symbols in the case of a compact construction of the display device.

According to an additional advantageous embodiment of the invention, it is preferred for the optical display device to be attached in a movable way in the rotating disk and to be connected to a switch-key or a switch, which can be actuated by shifting the display device (claim 6). This type of design provides an additional functionality of the electrical switching and/or setting element itself, by allowing, besides the switching possibility with the rotary switch, an additional switching possibility by means of the switch-key or switch, and this in a comparatively small space.

An electrical power supply and control signals for the display unit are transmitted advantageously through a shaft of the rotary switch. This also leads to a compact construction and additionally provides protection for the lines. The power supply as well as the control signals can here be carried by lines located in the interior of the shaft with hollow design (claim 8). In principle, the electrical power supply as well as the signals can be led through flexible lines placed in the interior of the shaft, to the connections of the switching and/or setting element. The lines are capable of withstanding without damage a certain amount of twisting. However, particularly in the case where the rotary switch must be capable of rotating multiple times through 360° without limit, other embodiments are possible, for example, leading the lines over sliding contacts.

In a particularly preferred embodiment, the electrical switching and/or setting element is designed as a potentiometer, preferably a push-pull potentiometer. However, this is not the only conceivable form.

Finally, an additional aspect of the invention consists of the use of an electrical switching and/or setting element as described above for operating and/or programming an electronic control. Here, the position of the rotary switch as well as a switch position of the optionally present switch-key or switch is evaluated by the control, to request or select menu items of an operating element.

For example, it is conceivable, in a menu structured like a tree, to select within a level individual menu items by rotating the rotary switch, where the position of the rotary switch is queried by a voltage that is connected to it or by such a current. By actuating the switch-key or switch by shifting the display unit in the rotation switch, the menu item can be selected or an additional submenu can be requested. In such a submenu, branches located in this level can again be selected by rotating the rotary switch.

In this application, the electrical switching and/or setting element according to the invention forms a particularly elegant and small operating unit, which generates feedback via a display device, which provides information on the given menu items that have just been selected.

Additional characteristics and advantages of the invention result from the following description of an embodiment example with reference to the single FIGURE in the appendix. This

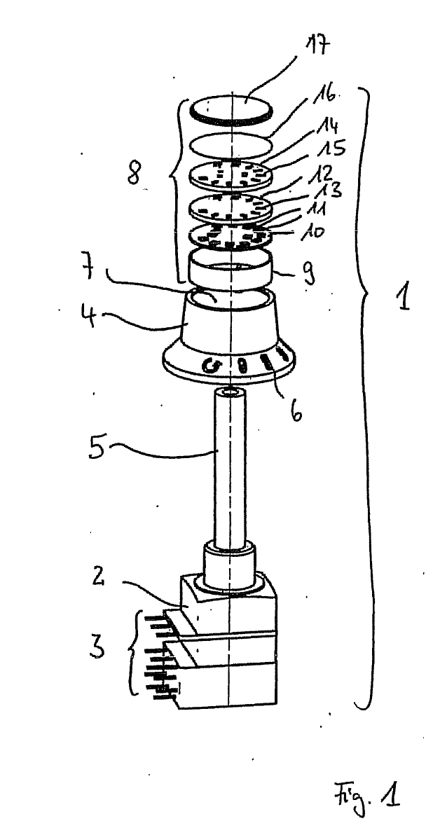

FIG. 1 shows an exploded view of an embodiment example of an electrical switching and/or setting element according to the invention.

The FIGURE is purely schematic, and one must keep in mind particularly that it is not to scale.

The FIGURE shows an electrical switching and/or setting element according to the invention in the form of a so-called push-pull potentiometer 1. The latter also contains, in addition to a switchgear unit 2 with electrical connections 3, a rotary switch 4. The latter is firmly connected to a shaft 5 that is connected to switch devices in the switchgear unit 2. The shaft 5 is designed to be hollow, for reasons to be described below.

Furthermore, the rotary switch 4 contains a collar with switch position symbol 6 applied to it. The rotary switch 4 is designed to be hollow with a reception space 7. In the reception space 7, a display device is accommodated, which overall bears the reference numeral 8. The display device 8 contains a support ring 9, a LED carrier 10 with LEDs 11 arranged on it, a shutter plate 12 with shutter openings 13, a mask 14 with symbol openings 15 arranged on it, a diffuser disk 16, and a cap 17 that covers the above-mentioned parts and is in the shape of a transparent converging lens made of plastic. In the assembled state, the entire display device 8 is accommodated in the reception space 7 in the rotary knob 4, and the cap 17 ends on the front side substantially flush with the rotary knob 4.

The entire display device 8 can be moved in the reception space 7 in the axial direction (with respect to the shaft 5) and it is connected to a switch-key. In this way, by applying pressure to the cap 17, the switch-key can be actuated, and a corresponding electrical signal can be generated. Through the interior of the shaft 5, which is of hollow design, lines are led for the electrical power supply or for controlling the light diodes 11, in order to illuminate the symbol openings 14 individually in this way.

The LED carrier 10, the shutter plate 12, and the mask 14 are oriented in such a way that in each case there is an aligned superposition of a LED 11, a shutter 12, and a symbol opening 15. In this way, one ensures that when one of the LEDs lights up, the light of this LED can pass through an associated shutter opening 13, with screening provided against any scattered light from other LEDs, and through the associated symbol opening 15, thus causing the corresponding symbol to light up. The LEDs 11 can be either individual LEDs or LED packets each with differently colored LEDs to allow additionally the individual symbols to light up in different colors, for example, yellow, red, green and blue.

The support ring 9 is used only to support the additional components of the display unit; the diffuser disk 16 serves to render uniform the light that exits from the symbol opening. The cap 17 functions, on the one hand, as a protection for the device, and, on the other hand, to enlarge the display of the symbols.

The push-pull potentiometer 1 is characterized by the fact that, by pulling on the rotary knob 4, the shaft 5 can be raised or lowered, which results in the selection of different switch levels of the switchgear unit 2. In a base position of a push-pull potentiometer 1, which is pressed down, a first switch level with first connections is actuated; in a raised position, a second switch level with second connections is actuated. This type of design, which in itself is known, increases the range of functionalities of this potentiometer.

The switch position symbols 6, which are arranged on the peripheral margin of the rotary switch 4, serve to simplify the operation, but they are not required obligatorily.

A preferred application of the switching and/or setting element according to the invention, consists of the use of a control, particularly a control of an automatic guitar tuning device, as is known, for example, from EP 1 596 359 A1. For this purpose, the push-pull potentiometer 1 according to the invention can be incorporated, for example, in a conventional E guitar, instead of the usual volume or sound control. For the following description, it is assumed that the push-pull potentiometer 1 is incorporated instead of the usual volume control. In the base position, that is with the shaft 5 pushed down, the potentiometer 1 thus functions as a conventional volume control. By pulling on the rotary switch 4 and shifting the shaft 5 or the switch element arranged on it into the raised position, a control for the automatic tuning of guitar strings is activated; in this position, on the display unit 8, the actuation is displayed, for example, all the LEDs can blink simultaneously, or they can light up successively through a sequence. Now, to select a menu, a rotation to the right or the left can be performed in a first level of the rotation switch 4 of the potentiometer 1, to select individual menu items. Here, in this design, it is preferred for the rotary switch 4 to present detent positions, whose sole function is to allow the haptic perception of the fact that menu positions have been reached. Then, an output signal of the potentiometer 1 is obtained, and evaluated with respect to current strength or voltage, to allow the assignment of a certain menu item to this signal. Accordingly, the display unit 8 provides feedback, where symbols that are assigned to certain menu items are displayed by lighting up the corresponding symbol openings 15 with the help of the associated LEDs 11. When the desired menu items have been reached, then this menu item is selected by actuating the switch-key, i.e., by pressing the display device 8 down. This menu item can now be an additional submenu, which in turn allows the selection of different menu items. These submenu items can be addressed in the same way by rotating the rotary switch 4, as described above. Here again, symbols are depicted that correspond to the individual menu items, where the symbols do not have to be the same symbols as displayed in the first menu level. Indeed, it is more advantageous if they are different symbols, to simplify the operation of the control for an operator.

In this way, an operator can obtain guiding information through different menu levels leading to an individual command, and then confirm the command by actuating the switch-key.

In each menu level, a menu item is provided, which, when called, results in the system switching to a higher menu.

By means of such a control, it is possible, for example, to predetermine certain frequencies to which a guitar string or similar part is to be tuned. Using this type of menu control, one can even program the system in such a way that certain harmonies or chord sounds involving different strings can be programmed, and stored in memory so they can be requested for later tuning processes.

The description of the embodiment example is not limiting; in particular, the electrical switching and/or setting element according to the invention can also be used for other purposes than those described above. Here, numerous possibilities are conceivable, which the person skilled in the art will recognize without problem. In particular, this electrical switching and/or setting element can be used not only to program control processes and for the automatic tuning of guitars, it can also be used for any type of controls or for small computers. The advantage of the electrical switching and/or setting element according to the invention is that it is not only suitable for issuing a signal, i.e., for requesting data, it is also capable itself of representing data thus providing feedback to the user.

### LIST OF REFERENCE NUMERALS

1 Push-pull potentiometer
2 Switchgear unit
3 Electrical connections
4 Rotary switch
5 Shaft
6 Switch position symbol
7 Reception space
8 Display device
9 Support ring
10 LED carrier
11 LED
12 Shutter plate
13 Shutter openings
14 Mask
15 Symbol opening
16 Diffuser disk
17 Cap

1. An electrical switching and setting element with a rotary switch as a handle, wherein the rotary switch includes an optical display device arranged for displaying at least two different symbols.

2. The electrical switching and setting element according to claim 1, wherein the optical display unit contains active light sources with openings formed to the shape of the at least two different symbols.

3. The electrical switching and setting element according to claim 13 wherein shutter openings are arranged between the light source and the mask.

4. The electrical switching and setting element according to claim 3, wherein at least one diffuser is arranged on the side of the mask which is turned away from the light sources.

5. The electrical switching and setting element according to claim 2, wherein the optical display device is covered by a transparent cap,

6. The electrical switching and setting element according to claim 1, wherein the optical display device is attached in a movable way in the rotary switch and is connected to one of a switch-key and switch, which is actuated by a shifting of the optical display device.

7. The electrical switching and setting element according to claim 1, wherein the rotary switch presents a shaft through which at least one of an electrical power supply and control lines for the optical display unit are carried.

8. The electrical switching and setting element according to claim 7, wherein the shaft is designed to be hollow, and the at least one of the electrical power supply and control lines are led in its interior.

9. The electrical switching and setting element according to claim 1, wherein the element is a potentiometer.

10. Method of using an an electrical switching and setting element for the operation and programming of an electronic control, wherein said electrical switching and setting element includes a rotary switch as a handle and the rotary switch includes an optical display device arranged for displaying at least two different symbols, and wherein a position of the rotary switch is evaluated by the control, to request or select menu items from an operating menu.

11. The electrical switching and setting element according to claim 2, wherein the light sources are LEDs.

12. The electrical switching and setting element according to claim 11, wherein the LEDs' are colored.

13. The electrical switching and setting element according to claim 12, wherein the LEDs include a mask applied thereon.

14. The electrical switching and setting element according to claim 5, wherein the cap presents the shape of a converging lens.

15. The electrical switching and setting element according to claim 9, wherein the element is a push-pull potentiometer.

16. An electrical switching element with a rotary switch as a handle, wherein the rotary switch includes an optical display device arranged for displaying at least two different symbols.

17. An electrical setting element with a rotary switch as a handle, wherein the rotary switch includes an optical display device arranged for displaying at least two different symbols.
